(19) United States
(12) Patent Application Publication
(10) Pub. No.: US 2007/0297479 A1
(43) Pub. Date: Dec. 27, 2007

(54) TRIGGERED SPARK GAP

(75) Inventor: Timothy Swinney, Clovis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Hercules, CA (US)

(21) Appl. No.: 11/766,008

(22) Filed: Jun. 20, 2007

Related U.S. Application Data
(60) Provisional application No. 60/805,585, filed on Jun. 22, 2006.

(51) Int. Cl. H01S 3/223

(52) U.S. Cl. 372/58

(57) ABSTRACT

A spark gap discharger includes a barrier structure having elements that reduce or prevent the buildup of a conductive surface path between electrodes due to the deposition of ablated electrode material on the inner walls of the spark gap chamber. The insulator body structure of the spark gap discharger includes one or more concentric insulator sleeves positioned inside the spark gap so that metal ablated from the electrodes during firing preferentially deposits on the insulator sleeve(s). The sleeve(s) are arranged such that a conductive path due to metal deposition on the inner walls of the body structure between one electrode and the other cannot form. Spark gap dischargers according to aspects of the present invention advantageously exhibit longer useful lifetimes than prior art spark gap dischargers.

### CROSS-REFERENCES TO RELATED APPLICATIONS

This application claims the benefit of U.S. Provisional Application Ser. No. 60/805,585 (Attorney docket No. 026693-019100US), filed Jun. 22, 2006, the disclosure of which is incorporated herein by reference in its entirety.

### BACKGROUND

The present invention relates generally to triggerable spark gap dischargers, and more particularly to triggerable spark gap dischargers for use as a high voltage switch for gas discharge lasers.

Spark gaps have been used for many years for many applications. For example, spark gaps are used to fire high explosives, protect large high voltage power grids and other devices such as klystrons from voltage transients, and to fire gas discharge lasers, e.g., switch high voltages very fast (e.g., on the order of nanoseconds).

A triggered spark gap discharger typically includes two main electrodes defining a main spark gap. A trigger electrode proximal to one of the main electrodes (anode) defines a secondary gap; the trigger electrode is used to fire the main spark gap. The spark gap discharger is filled with a gas mixture for hold off voltage and stable operation. To fire the spark gap, one electrode (cathode) is charged up to a high voltage, e.g., around 18 KV. The spacing of the main spark gap and the pressure of the gas mixture are sufficient to hold off the main spark gap from spontaneously breaking down. A negative high voltage is applied to the trigger pin. This increases the effective voltage on the main spark gap above the hold off voltage, and seeds ions into the main spark gap region as the gas between the trigger pin and the anode breaks down. Alternatively, opposite polarity voltages may be used to fire the spark gap. For example, a positive high voltage could be applied to the trigger pin with reversed polarities on the electrodes. When the main spark gap fires there is a lightning bolt break down between the anode and cathode. This super heats the gas in the gap and as a result material is ablated off the electrodes. Some of this ablated metal deposits onto the inner surface of the spark gap chamber, and a conductive metal film builds up and eventually the gap fails due to arcing on a surface path between the electrodes along the inner walls of the chamber.

Accordingly, it is desirable to provide spark gap dischargers that overcome the above and other problems. In particular, the spark gap discharger should reduce or eliminate the ability of a conductive path to form between electrodes so as to extend the useful lifetime of the discharger.

### BRIEF SUMMARY

The present invention provides a spark gap discharger that include a barrier structure having one or more elements to prevent or reduce buildup of a conductive path between spark gap electrodes. In certain aspects, one or more sleeves or rings of insulator material are disposed within the chamber of the discharger. The insulator sleeve(s) prevent or reduce buildup of a conductive path between electrodes from ablated electrode material so as to extend the useful lifetime of the discharger.

According to one aspect of the present invention, a spark gap discharger is provided that typically includes a body structure having an axis and having opposing inner end walls and an inner sidewall defining an enclosed spark chamber, where the body made of insulator material. The discharger also typically includes a first electrode disposed within the body proximal to a first endwall, and a second electrode disposed within the body proximal to a second endwall opposite the first electrode so as to define a spark gap between the first and second electrodes. The discharger also typically includes a barrier structure disposed within the body between the inner sidewall and one or both electrodes, wherein the barrier structure prevents a conducting path from forming between the first and second electrodes along the inner sidewall due to deposition of ablated electrode material along the inner sidewall.

In certain aspects, the barrier structure includes a first sleeve of insulator material disposed within the body between the inner sidewall and the electrodes. In one aspect, the first sleeve is coupled to the first endwall and extends toward the second endwall, and the first sleeve does not extend the length of the sidewall so that a gap exists between an end of the sleeve and the second endwall. In another aspect, the first sleeve axially extends between the endwalls, and a gap exists between an end of the first sleeve and at least one of the first and second endwalls. In yet another aspect, the first sleeve is coupled to the sidewall and includes a portion that axially extends between the endwalls. In yet another aspect, the first sleeve is coupled to the sidewall and extends towards one of the first or second endwalls.

Reference to the remaining portions of the specification, including the drawings and claims, will realize other aspects, features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1a shows a cross-sectional side view of a triggerable spark gap discharger having a barrier structure including sleeve or ring elements according to an embodiment of the present invention.

FIG. 1b shows a cross-sectional perspective view of the triggerable spark gap discharger of FIG. 1a.

FIG. 2 shows a cross-sectional side view of a triggerable spark gap discharger having a barrier structure including a sleeve or ring element configuration according to another embodiment of the present invention.

FIG. 3a and 3b illustrate perspective views of a laser tube for a gas discharge laser.

FIG. 4 illustrates a circuit diagram including a spark gap discharger coupled to electrodes and a pre-ionizer of a laser tube for a gas discharge laser.

FIG. 5 illustrates different barrier structure configurations according to aspects of the present invention.

### DETAILED DESCRIPTION

The present invention provides a spark gap discharger including elements that reduce or prevent the buildup of a conductive surface path between electrodes due to the deposition of ablated electrode material on the inner walls of the spark gap chamber. In one aspect, the insulator body structure of the spark gap discharger includes one or more concentric insulator sleeves or rings positioned inside the spark gap so that metal ablated from the electrodes during firing preferentially deposits on the insulator sleeve(s). The sleeve(s) are arranged such that a conductive path due to metal deposition on the inner walls of the body structure between one electrode and the other cannot form. Advantageously, spark gap dischargers according to aspects of the present invention exhibit a longer useful lifetime than prior art spark gap dischargers.

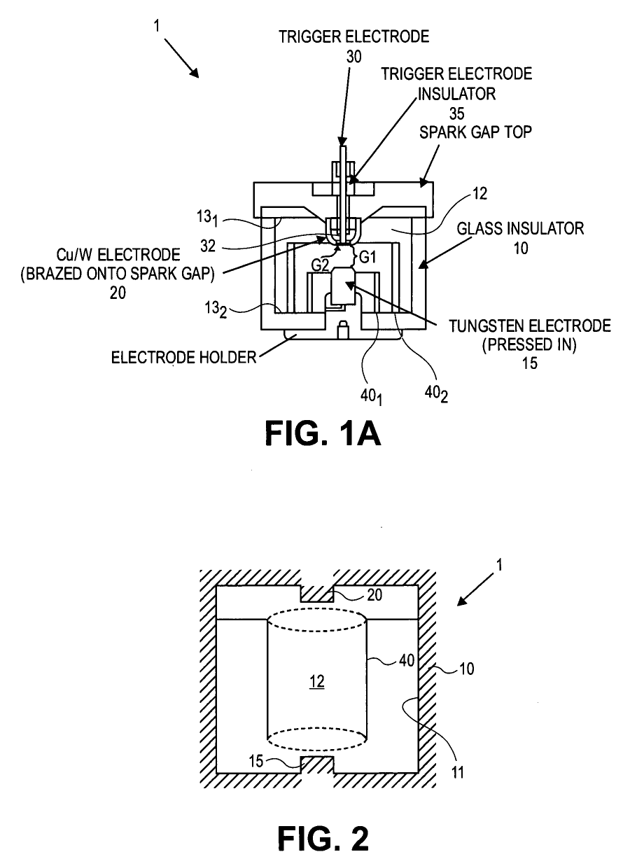

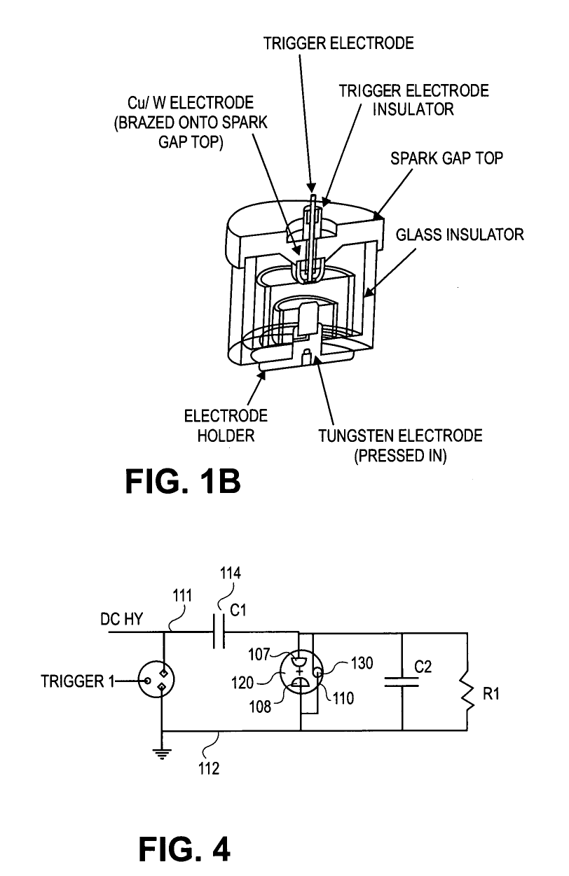

FIG. 1a show a side cross-section of a triggerable spark gap discharger 1 according to an embodiment of the present invention. The spark gap discharger 1 includes a body 10 that defines a spark chamber 12. Body 10, in one aspect, is substantially cylindrical, having a circular cross-section as can be seen in the perspective view of FIG. 1b. Body 10 includes two inner endwalls 13 and a cylindrical inner sidewall 11 defining a spark chamber 12. Body 10 need not have a circular cross-section and can take on any of a variety of shapes, e.g., rectangular, oval, square, hexagonal, etc. Discharger 1 includes a pair of primary electrodes 15 and 20 disposed on, or proximal to, opposing endwalls 13 of the body 10 as shown. Body 10 is preferably made of an insulating material such as a glass, a ceramic, porcelain, etc. Electrode 20 includes an axially aligned trigger probe or pin 30 extending therethrough, which is insulated from electrode 20 by an insulator 35, e.g., a glass or porcelain tube. In certain aspects, the spark gap discharger chamber 12 is filled with an ionizable gas which, for example, may be pure nitrogen, or a mixture of gases such as nitrogen and a small amount of oxygen and/or other constituents. In one aspect, the gas mixture used is 5% krypton, 1% oxygen, and the balance (94%) nitrogen. Other useful ionizable gases and gas mixtures will be readily apparent to one skilled in the art. For example, U.S. Pat. No. 4,939,418, which is hereby incorporated by reference, discloses other useful gas mixtures for triggerable spark gaps.

In one aspect, electrodes 15 and 20 are made of Tungsten (W), however other useful Tungsten based materials such as Cu/W may be used. For example, in one aspect, electrode 20 includes Cu/W material brazed onto a spark gap tap. Cu/W (copper tungsten) is commonly known by the trade name of Elkonite™. Tungsten-based materials are preferred due to the high temperatures involved during discharge, however, any other conductive materials may be used for the various electrodes. In certain aspects, the discharger 1 is about 2″ high (axial length) and about 1.75″ in diameter. However, the size of the discharger may vary widely, for example, the height may vary from about 0.5″ to about 4″ or larger, and the diameter may vary from about 0.5″ to about 4″ or larger.

A gap G1 between electrodes 15 and 20 is the primary gap for discharge of high voltage applied across electrodes 15 and 20 via terminals (not shown) coupled with a high voltage source. The pair of electrodes 15 and 20 are spaced far enough apart such that the voltage applied across the electrodes is insufficient to electrically breakdown the gap (G1) therebetween. The gap remains a very good insulator at voltages below its hold-off value. When it is desired to initiate a flow of current, sufficient ionization of the gas between the electrodes must occur to allow the gap G1 to break down. This may be accomplished by a sudden increase of the voltage across the gap, a sudden reduction in the gap spacing, a sudden reduction in gas density, natural radioactive irradiation of the gap, ultraviolet irradiation of the gap, a heated filament in the gas dielectric, distortion of the electric field of the gap, or injection of ions and/or electrons into the gap.

In one aspect, a trigger spark gap G2 is present between the tip 32 of trigger probe 30 and primary electrode 20. A trigger pulse (e.g., square wave or other pulsed waveform) is applied between trigger probe 30 and main electrode 20 via a second set of terminals (not shown) coupled with a voltage pulse source (not shown). The trigger gap G2 breaks down under the influence of the trigger pulse to provide a source of electrons or ions to initiate the breakdown of the primary gap G1. Upon application of a trigger pulse, an auxiliary spark is generated inside the gap G2 between the trigger probe 32 and the primary electrode 20; the auxiliary spark provides a source of electrons and ions and forms a low-density region due to the energy dissipated by the trigger spark.

In one embodiment, a barrier structure including one or more concentric cylindrical (insulator) sleeves or rings 40 are positioned in the spark gap between the axis defined by the electrodes 15 and 20 and the inner sidewall 11 of body 10 as shown in FIG. 1a. Inclusion of one or more sleeves 40 or similar baffle elements provides a barrier structure that advantageously prevents formation of a conductive path between one electrode and the other electrode on the inner wall 11 of body 10 due to metal deposition caused by ablation of electrode material upon discharge. For example, material ablated from the electrodes preferentially deposits on the inner surfaces of the sleeve(s) 40 (facing the electrodes), preventing a full surface conductive path from forming between electrodes 15 and 20. It is possible that ablated material may deposit on the outer surfaces of the sleeve(s) 40 (facing sidewall 11), but it would occur at a much slower rate than deposition on the inner surfaces due to the geometry of sleeves 40 and the kinetic path of ablated material.

In certain aspects, a sleeve 40 is coupled to, or integral with, one endwall 13 of the chamber defined by body 10. For example, a sleeve may be formed separately and attached to an endwall 13 of body 10, or a sleeve may be formed as part of the process of forming body 10. In certain aspects, a sleeve extends parallel to the axis part of the way to the opposite endwall such that a gap exists between one endwall and the end of the sleeve. For example, as shown in FIGS. 1a and 1b, sleeve 40₂ extends from endwall 13₂ toward endwall 13₁. In this manner, a surface conductive path will not form between the two electrodes as ablated electrode material will preferentially deposit on the inner surface portion of the sleeve up to the top of the sleeve; the ablated material will not deposit on the outer surface of the sleeve and thus a full conductive path between electrodes will not form.

It should be appreciated that the cross-sectional geometry of a sleeve 40 may be circular, elliptical, square, or a combination thereof, and that the a sleeve need not be axially aligned. Also, the height of each sleeve may be variable, and where more than one sleeve is implemented, the relative heights of the sleeve may vary. For example, as shown in FIG. 1, the innermost sleeve 40₁ is shorter than the outermost sleeve 40_{2.} Also, a sleeve 40 can be formed on or integral with either endwall 13 that is contiguous with an electrode 15 or 20. For example, a sleeve 40 may be formed on or integral with endwall 13₁ rather than endwall 13₂ as is shown in FIG. 1. Where more than one sleeve is implemented, one sleeve may be formed on or integral with one endwall 13 and another sleeve may be formed on or integral with the opposite endwall 13, e.g., interleaved sleeves with respective gaps at opposite endwalls. It should be appreciated that a sleeve should be spaced sufficiently far from an electrode so that an arcing event between an electrode and a partial conductive path due to material deposited on a sleeve will not occur. For example, with reference to FIG. 1a, a partial conductive path may form on the inner surface of sleeve 40₁ so that the top of sleeve 40₁ may have conductive material at the same potential as electrode 15. In this case, the nearest distance between sleeve 40₁ and electrode 20 is preferably greater than the gap distance G1 between the electrodes. In general, it is preferred that the shortest gap be between the electrodes; all gaps between sleeve(s) and an electrode should be larger than the gap G1 between electrodes. For cylindrical sleeves as shown in FIG. 1, it is preferred that a sleeve 40 extend far enough to more effectively prevent ablated electrode material from forming on the back side, for example from about 30% or 40% of the distance between end walls up to about 98% or 99% of the distance between endwalls.

In certain aspects, a sleeve need not be attached to an endwall 13. Rather, in one embodiment as shown in FIG. 2, a cylindrical sleeve or ring 40 is coupled to, or integral with, sidewall 11. For simplicity, only main electrodes 15 and 20 are shown and only one ring 40 is shown.

In certain aspects, the triggered spark gap devices of the present invention are particularly useful as a switching device in gas lasers, e.g., for firing gas discharge lasers. A triggered spark gap is used in gas lasers to switch high voltages very fast (e.g., on the order of nanoseconds).

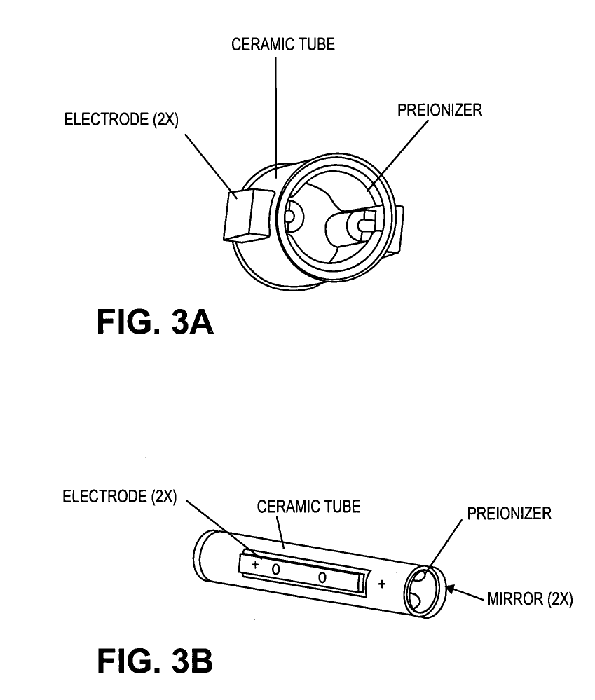

FIGS. 3a and 3b show different perspective views of an example of a laser tube for a gas discharge laser. The laser tube typically includes a ceramic tube with electrodes brazed in on each side of the tube, and a pre-ionizer which in certain aspects includes a wire making contact with one electrode and an insulator making contact with the other. The laser tube also include a fill tube (not shown) used to evacuate and back fill the laser tube with low pressure nitrogen (or other gas), and mirrors on each end, one being a high reflector the other an partially reflecting output coupler. The laser tube fires when very fast high voltage pulse is applied to the electrodes. In one aspect, the tube is about 4″ long and 0.75″ diameter, although other tube sizes will be readily apparent to one skilled in the art.

FIG. 4 illustrates a circuit diagram including a spark gap discharger 1 electrically coupled with electrodes 107 and 108 and a pre-ionizer 130 of a laser tube of FIG. 3. An elongated ceramic laser housing 110 has a central gas cavity 120 and end apertures for attachment of optical reflector mounts, thus defining a central optical axis (“+”). The present gas laser is assumed to be a closed cavity laser for sealed operation, although suitable passages (not shown) through the walls of the housing 110 may be provided to operate as a circulating gas laser. Electrodes 107 (e.g., anode) and 108 (e.g., cathode) are bonded or otherwise secured in the top and bottom, respectively, of the housing 110; these electrodes extending substantially the full length of the housing as shown in FIG. 3. Electrical leads 111 and 112 are connected through the housing to the anode and cathode for further connection to a high voltage pulse system. Anode lead 111 connects to one side of a spark gap discharger 1 and to a discharge capacitor 114. Cathode lead 112 also connects to ground. A high voltage DC source of suitable nature is connected across the capacitor 114. This assembly forms a typical transversely excited glow discharge gas laser, which may use Nitrogen, for example. When a high voltage DC is applied to the input, the spark gap 1 automatically sparks over each time the capacitor 114 reaches the required charge voltage. The resulting pulses of high voltage across the electrodes 107 and 108 ionize the contained gas and form a glow discharge therein, the main glow discharge volume being substantially bounded by the outer edges of the electrodes 107 and 108 as indicated in FIG. 4.

With reference to FIG. 1, to fire the spark gap, the tungsten electrode 15 (cathode) is charged up to a high voltage, e.g., between 10 and 25 kV. The spacing in the gap G1 and the pressure of the gas in the gap are sufficient to hold off the gap from spontaneously breaking down. A negative high voltage is sent to the trigger pin which increases the effective voltage on the gap above the hold off voltage and seeds ions into the gap region as the gas between the trigger pin and the anode breaks down. When the gap fires there is a lightning bolt break down between the anode and cathode. This super heats the gas in the gap and ablated material off the electrodes. Some of this material deposits onto the inner surface of the concentric rings. With out the ring(s) a conductive film builds up and eventually the gap would fail due to arcing on a surface path. Most spark gap manufactures of this size and type guarantee around 20 million shots. Advantageously, spark gap dischargers according to the present invention are expected to last well over 100 million shots; the spark gap discharger would fail long after the laser tube.

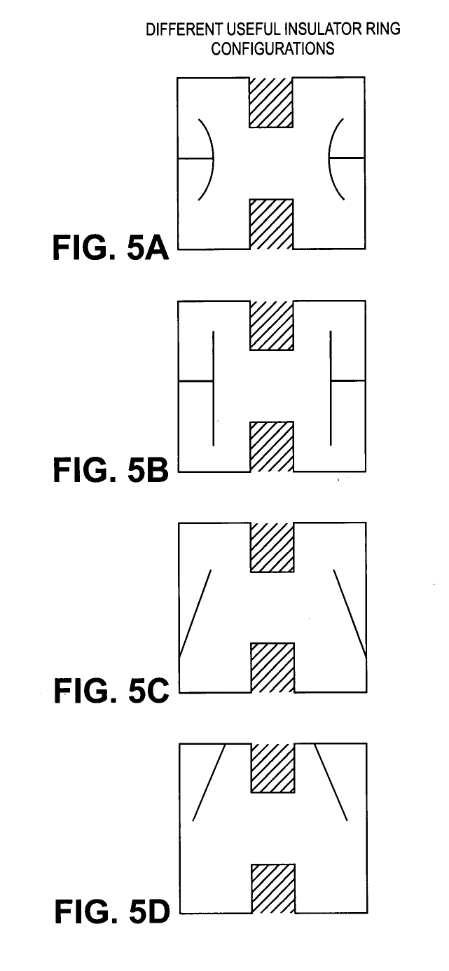

FIG. 5 illustrates cross-sectional side views of additional barrier structure configurations according to the present invention. As shown in FIGS. 5a and 5b, a sleeve is coupled to the sidewall. In FIG. 5a, a portion of the sleeve forms a cylindrical-hyperboloid barrier surface, and in FIG. 5b, a portion of the sleeve forms a cylindrical barrier surface. In FIG. 5c, a sleeve is coupled with a sidewall and extends toward an endwall in a non-axial manner, e.g., not parallel to axis between electrodes. In FIG. 5d, a sleeve is coupled with an endwall and extends toward the sidewall. One skilled in the art will realize other similar configurations.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A spark gap discharger, comprising:
a body structure having an axis and having opposing inner endwalls and an inner sidewall defining an enclosed spark chamber, said body made of insulator material;
a first electrode disposed within the body proximal to a first endwall;
a second electrode disposed within the body proximal to a second endwall opposite the first electrode so as to define a spark gap between the first and second electrodes; and
a barrier structure disposed within the body between the inner sidewall and one or both electrodes, wherein said barrier structure prevents a conducting path from forming between the first and second electrodes along the inner sidewall due to deposition of ablated electrode material along the inner sidewall.

2. The discharger of claim 1, wherein the barrier structure includes a first sleeve of insulator material disposed within the body between the inner sidewall and the electrodes.

3. The discharger of claim 2, wherein the first sleeve is coupled to the first endwall and extends toward the second endwall, and wherein the first sleeve does not extend the length of the sidewall so that said gap exists between an end of the sleeve and the second endwall.

4. The discharger of claim 2, wherein said first sleeve axially extends between the endwalls, and wherein a gap exists between an end of the first sleeve and at least one of the first and second endwalls.

5. The discharger of claim 2, wherein the first sleeve is coupled to the sidewall and includes a portion that axially extends between the endwalls.

6. The discharger of claim 2, wherein the first sleeve is coupled to the sidewall and extends towards one of the first or second endwalls.

7. The discharger of claim 2, further including a second sleeve of insulator material disposed within the body between the inner sidewall and the first sleeve.

8. The discharger of claim 7, wherein the first sleeve is coupled to the first endwall and extends toward the second endwall, and wherein the second sleeve is coupled to the second endwall and extends toward the first endwall.

9. The discharger of claim 7, wherein the first sleeve is coupled to the first endwall and extends toward the second endwall, and wherein the second sleeve is coupled to the first endwall and extends toward the second endwall.

10. The discharger of claim 9, wherein said gap between the first sleeve and the second endwall is larger than a gap between the second sleeve and the second endwall.

11. The discharger of claim 1, wherein the first and second electrodes are made of a conductive metal.

12. The discharger of claim 1, wherein the conductive metal includes Tungsten (W).

13. The discharger of claim 1, wherein the body structure is substantially cylindrical.

14. The discharger of claim 2, wherein the first sleeve is substantially cylindrical.

15. The discharger of claim 1, wherein the body structure is made of insulator material selected from the group consisting of a glass and a ceramic material.

16. The discharger of claim 1, wherein a distance between the barrier structure and each of the first and second electrodes is greater that the distance of the spark gap between the first and second electrodes.
